(19) United States
(12) Patent Application Publication
(10) Pub. No.: US 2008/0191476 A1
(43) Pub. Date: Aug. 14, 2008

(54) JOINT FOR MEASURING DEVICE AND METHOD OF MANUFACTURING THE JOINT

(75) Inventors: Satoshi KAWASAKI, Tokyo (JP); Yasutaka IDE, Tokyo (JP); Kunihiro YAMAURA, Tokyo (JP)

Correspondence Address: Young & Thompson;2nd Floor, 745 S. 23rd Street, Arlington, VA, 22202, US

(73) Assignee: NAGANO KEIKI CO., LTD., Tokyo (JP)

(21) Appl. No.: 12/030,933

(22) Filed: Feb. 14, 2008

(30) Foreign Application Priority Data
Feb. 14, 2007 (JP) 2007-033368

(51) Int. Cl. F16L 25/00

(52) U.S. Cl. 285/328

(57) ABSTRACT

A joint for a measuring device includes a fluid introduction sleeve to which a body of a measuring device is mounted, a gasket holding member mounted to the fluid introduction sleeve so as to project over a front end of the fluid introduction sleeve, and a gasket having an annular shape and held by the gasket holding member. The gasket is held to the gasket holding member by plastically deforming the gasket in a radially inward direction thereof.

### BACKGROUND OF THE INVENTION

1. Field of the Invention

The present invention relates to a joint for a measuring device such as pressure sensor and a method of manufacturing the joint.

2. Related Art

A measuring device such as conventional pressure sensor is provided with a joint, through which the measuring device (pressure sensor body) is mounted to a predetermined set position. The joint is provided with a fluid introducing sleeve to which the measuring device is connected, and a gasket holding member having a diameter smaller than that of the fluid introducing sleeve projects over a front end surface of the fluid introducing sleeve.

A ring-shaped gasket is supported to this gasket holding member. The gasket is mounted such that a sealing surface of the gasket projects over the front end of the gasket holding member.

In general, the fluid introducing sleeve has a male-thread sleeve or cylinder, and the fluid is prevented from leaking by screwing and engaging the male-thread sleeve with a predetermined set position and sandwiching the gasket between the front end surface of the fluid introducing sleeve and the pressure sensor set position. (For example, refer to Japanese Patent Laid-open Publication No. 2005-114734: Patent Publication 1).

The gasket in such arrangement is often come off from the joint at a transportation time of the measuring device or in a mounting working thereof. Therefore, in order to obviate such coming off and loosening of the gasket, in the conventional art, the gasket is mounted to the joint of the measuring device or the set position just before the mounting of the measuring device.

In addition, in order to prevent the gasket from coming off and to smoothly perform the mounting working, the gasket is preliminarily fixed to the set position of the measuring device or the joint thereof by using a retainer or inserting a gasket coming-off preventing member. (For example, refer to Japanese Patent Laid-open Publication Nos. 2003-74766 and 2002-243042: Patent Publications 2 and 3).

In the conventional method mentioned above, in which the gasket is mounted to the joint of the measuring device or the predetermined set position at the setting working of the measuring device, there was a fear such that the measuring device setting working is liable to be made complicated and the connection of the joint is not accurately made.

Moreover, in the method for connecting the joint to the predetermined set position through a retainer so as to prevent the gasket from coming-off or losing, an additional member such as retainer is required, and it is obliged for the gasket to be worked for connection to the retainer, resulting in cost-up in manufacturing the measuring device. Furthermore, the mounting of the retainer requires an additional set space therefore, thus also being inconvenient.

### SUMMARY OF THE INVENTION

The present invention was conceived in consideration of the circumstances encountered in the prior art mentioned above and an object thereof is to provide a joint for a measuring device and a method of manufacturing the joint capable of eliminating the drawbacks in the prior art mentioned above.

The above and other objects can be achieved according to the present invention by providing, one aspect, a joint for a measuring device, comprising:

a fluid introduction sleeve to which a body of a measuring device is mounted;

a gasket holding member mounted to the fluid introduction sleeve so as to project over a front end of the fluid introduction sleeve; and

a gasket having an annular shape and held by the gasket holding member,

wherein the gasket is held to the gasket holding member by plastically deforming the gasket in a radially inward direction thereof.

According to this aspect of the present invention, the gasket can be prevented from coming off from the gasket holding member before the mounting to the measuring device. In addition, the joint can be surely connected to the predetermined set position of the measuring device.

Furthermore, since it is not necessary to locate an additional member such as retainer for fixing the gasket and form a space for arranging such retainer, the measuring device can be provided at cheep cost.

Since the gasket is fixed to the gasket holder by the plastic deformation in the radially inward direction, the seal surfaces are not deformed, and accordingly, the gasket can be smoothly contacted to the joint and the set position to thereby surely perform the sealing, thus preventing fluid from leaking.

In a preferred embodiment of the above aspect, the gasket may be held by the gasket holding member such that a seal surface of the gasket projects over a front end of the gasket holding member.

According to this feature, the seal surface of the gasket can be easily contacted to the set position of the measuring device.

Further, the gasket may be formed, in an inner peripheral surface thereof, with a plastically deformable portion, and the gasket holding member may be formed, in an outer peripheral surface thereof, with a groove into which the plastically deformable portion is intruded.

The gasket holding member may be formed, in an outer peripheral surface thereof, with a projection, which contacts to an inner peripheral surface of the gasket.

Further, the groove may have a tapered wall widening toward the front end of the gasket holding member, or the projection may have a tapered wall widening toward the front end of the gasket holding member.

According to the above features, the gasket can be further prevented from coming off from the gasket holding member.

Further, it may be desired that the measuring device is a pressure sensor.

When the measuring device is a pressure sensor, even if a load by a fluid pressure is applied, the leakage of the fluid can be surely prevented.

Further, it may be desired that the gasket is formed of a material softer than that of the gasket holding member.

According to this feature, the gasket can be easily plastically deformed.

Further, the fluid introduction sleeve may be a screw cylinder screwed with a predetermined set position of the measuring device.

According to this feature, the gasket can be easily plastically deformed by the screw engagement between the fluid introduction sleeve and the set position of the measuring device in a tightly contacted manner.

In another aspect of the present invention, there is also provided a method of manufacturing a joint for a measuring device comprising the steps of:

preparing a fluid introduction sleeve connected to a measuring device and a gasket holding member mounted to the fluid introduction sleeve so as to project over a front end surface of the fluid introduction sleeve;

applying a gasket to the gasket holding member; and

pressing the gasket in a radially inward direction against an outer peripheral surface of the gasket holding member to thereby form a plastically deformable portion to an inner peripheral surface of the gasket to thereby mount the gasket to the gasket holding member.

According to this aspect of the present invention, the gasket can be prevented from coming off from the gasket holding member before the mounting of the measuring device. In addition, the joint can be surely connected to the predetermined set position of the measuring device in a desired orientation and attitude thereof.

Furthermore, since it is not necessary to locate an additional member such as retainer for fixing the gasket or form a space for arranging such retainer, the measuring device can be provided at cheep cost.

Since the gasket is fixed to the gasket holder by the plastic deformation in the radially inward direction, the seal surfaces are not deformed, and accordingly, the gasket can be smoothly contacted to the joint and the set position to thereby surely perform the sealing, thus preventing fluid from leaking.

Further, in this method, it may be desired that the gasket is pressed in the radially inward direction, and simultaneously, the gasket is pressed in an axial direction.

According to this feature, the gasket is plastically deformable in the radially inward direction, but prevented from being deformed in the axial direction, thus surely maintaining the flatness of the seal surface of the gasket and maintaining the improved sealing performance.

Further, it may be desired that at least a pair of jigs are prepared, and the gasket is sandwiched by the jigs from the outer peripheral side thereof to thereby plastically deform the gasket.

According to his feature, the gasket can be plastically deformable in a good balance in the radially inward direction, and can be preferably prevented the gasket from coming off.

The gasket may be pressed radially inward by the at least a pair of jigs, and simultaneously, the gasket is pressed in the axial direction thereby by sandwiching the gasket between the fluid introduction sleeve and another jig.

According to this feature, the gasket can be plastically deformable in a good balance in the radially inward direction, and the deformation of the seal surface can be preferably prevented, thus surely preventing the gasket from coming off, preventing the sealing performance from lowering and preventing the fluid from leaking.

The nature and further characteristic features of the present invention will be made clearer from the following descriptions made with reference to the accompanying drawing.

### BRIEF DESCRIPTION OF THE DRAWINGS

In the accompanying drawings:

FIG. 1 is a vertical sectional view of a pressure sensor as a measuring device according to a first embodiment of the present invention;

FIG. 2 is an enlarged view of an essential portion of the pressure sensor shown in FIG. 1;

FIG. 3 includes FIGS. 3A to 3C illustrating a process of mounting a gasket to a joint of the pressure sensor of FIG. 1;

FIG. 4 includes FIGS. 4A and 4B illustrating another process of mounting a gasket to a joint of the pressure sensor of FIG. 1;

FIG. 5 includes FIGS. 5A to 5D illustrating sectional views representing modified examples of gaskets;

FIG. 6 illustrates a modified example of a jog of the first embodiment;

FIG. 7 includes FIGS. 7A to 7D illustrating modified examples of abutting edges of the jig of the first embodiment;

FIG. 8 includes FIGS. 8A and 8B illustrating a modified example of a jog of the second embodiment;

FIG. 9 is a sectional view showing a modified example of a pressure sensor of the first embodiment for explaining a fixing method of the pressure sensor; and

FIG. 10 includes FIGS. 10A and 10B illustrating modified example of cutout portions of the jigs of the first embodiment.

### DESCRIPTION OF THE PREFERRED EMBODIMENTS

Respective embodiments of the present invention will be described hereunder with reference to the accompanying drawings.

### First Embodiment

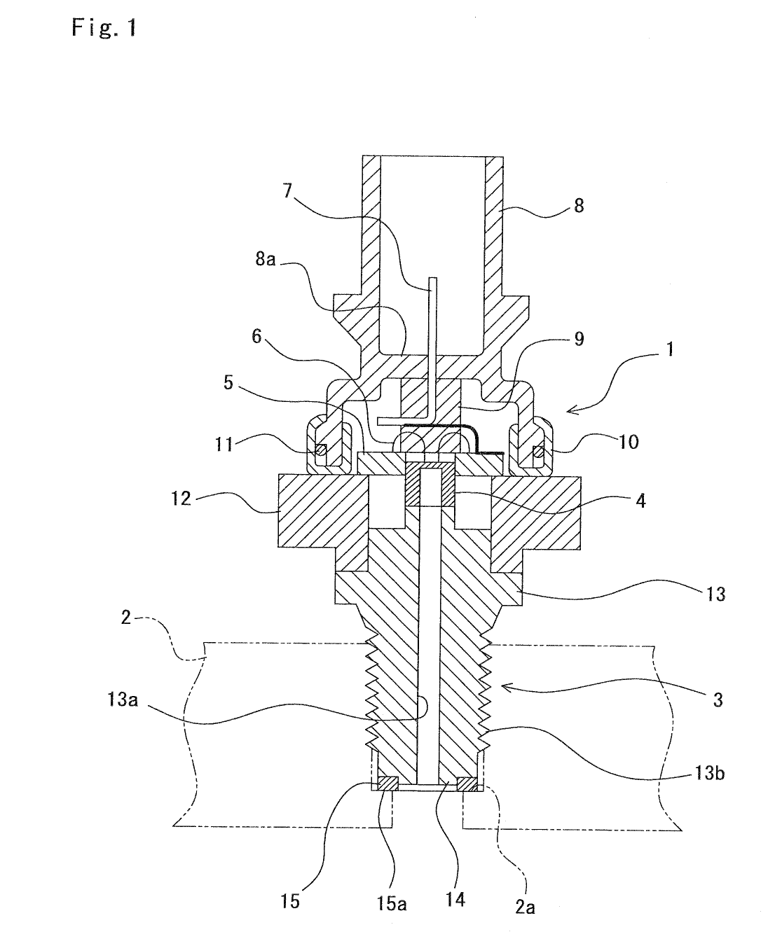

A measuring device shown in FIG. 1 is a pressure sensor for measuring a pressure of a fluid such as liquid, and includes a pressure sensor body 1 and a joint 3 for mounting the pressure sensor body 1 to a predetermined set position 2 of a member to which the measuring device is mounted.

The pressure sensor body 1 includes a pressure detection element 4, having a diaphragm, to which a strain gauge for converting the fluid pressure to an electric signal is provided and a circuit unit or element 5 for generating an electric signal corresponding to the pressure detected by the pressure detection element 4. The pressure detection sensor 4 and the circuit element 5 are electrically connected to each other through a wire 6, and a terminal 7 for transmitting the electric signal outward the pressure sensor projects from the circuit element 5.

The circuit element 5 and the terminal 7 are surrounded by a cylindrical housing 8 so as to be protected thereby. The terminal 7 projects outward over a shielding wall 8a of the housing 8. The terminal 7 is formed integrally with a terminal base 9, which is fixed to a case 10 by means of calking.

An O-ring 11 is inserted between the housing 8 and the case 10 so as to be shut off from the outer environment thereof.

The case 10 is coupled to a flanged member 12 by means of welding. The flanged member 12 has an outer polygonal configuration so as to be easily rotated by a spanner or wrench. The circuit element 5 is fixed to the flanged member 12 inside the case 10.

The joint 3 has a fluid introduction sleeve 13 to which the pressure sensor body 1 is coupled. The fluid introduction sleeve 13 has a cylindrical structure made of, for example, a stainless steel, and is formed with a central fluid introduction port 13a along the axis thereof. The pressure detection element 4 is connected, by means of welding, to one end surface of the fluid introduction sleeve 13 so as to close the same.

Further, the flanged member 12 is coupled, by means of welding, around the fluid introduction sleeve 13 so as to surround the pressure detection element 4. It is of course possible to integrally form the flanged member 12 and the fluid introduction sleeve 13 at an initial working stage.

The fluid introduction sleeve 13 is formed as a screw cylinder provided with thread screwed with the predetermined set position 2 of the pressure sensor. Although this thread may be formed as a female screw thread in an inner surface of the fluid introduction port 13a when the set position 2 is formed so as to have a male screw thread, in this example, this thread is generally formed as a male screw 13b thread in the outer peripheral surface of the fluid introduction sleeve 13 as shown in FIG. 1.

The joint 3 is provided with a gasket holding member 14 projecting from the front end surface of the fluid introduction sleeve 13 and a ring-shaped (annular) gasket 15 held by the gasket holding member 14 such that a seal surface 15a of the gasket 15 projects over a front end of the gasket holding member 14.

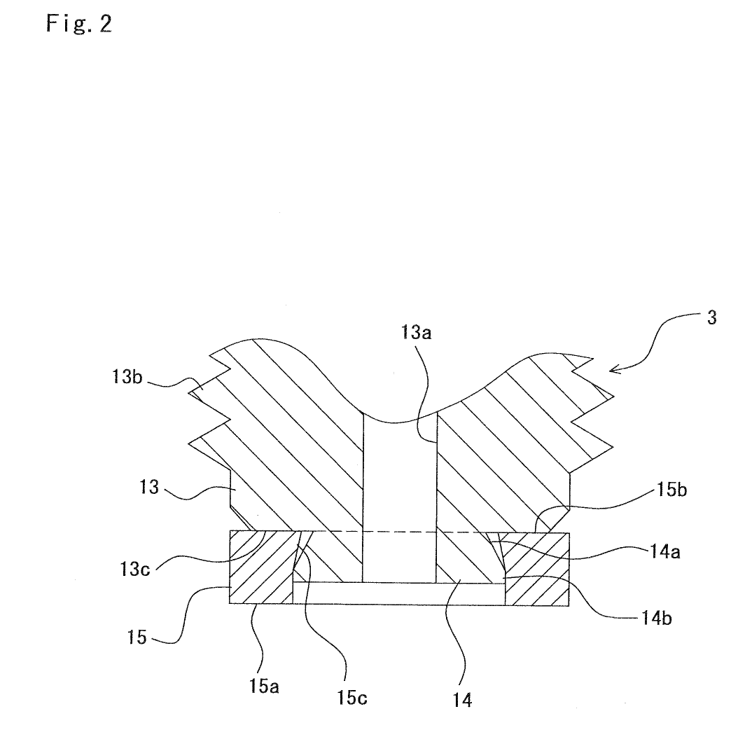

As shown in FIG. 2, the gasket holding member 14 is formed as a cylindrical member having an outer diameter smaller than that of the fluid introduction sleeve 13 in this first embodiment and formed integrally with the fluid introduction sleeve 13.

The gasket holding member 14 is formed, at its outer peripheral surface, with a tapered wall gradually widening toward the front end of the gasket holding member 14 to thereby provide an annular groove 14a and an annular projection 14b. The tapered wall may not be formed, and in such case, the outer peripheral surface of the gasket holding member 14 may be formed as cylindrical wall to which one or both of the annular groove and the annular projection may be formed.

On the other hand, intermittent grooves or projections may be formed in place of the annular ones.

An entire or partial portion of the annular end surface 13c of the fluid introduction sleeve 13 is formed as an flat surface.

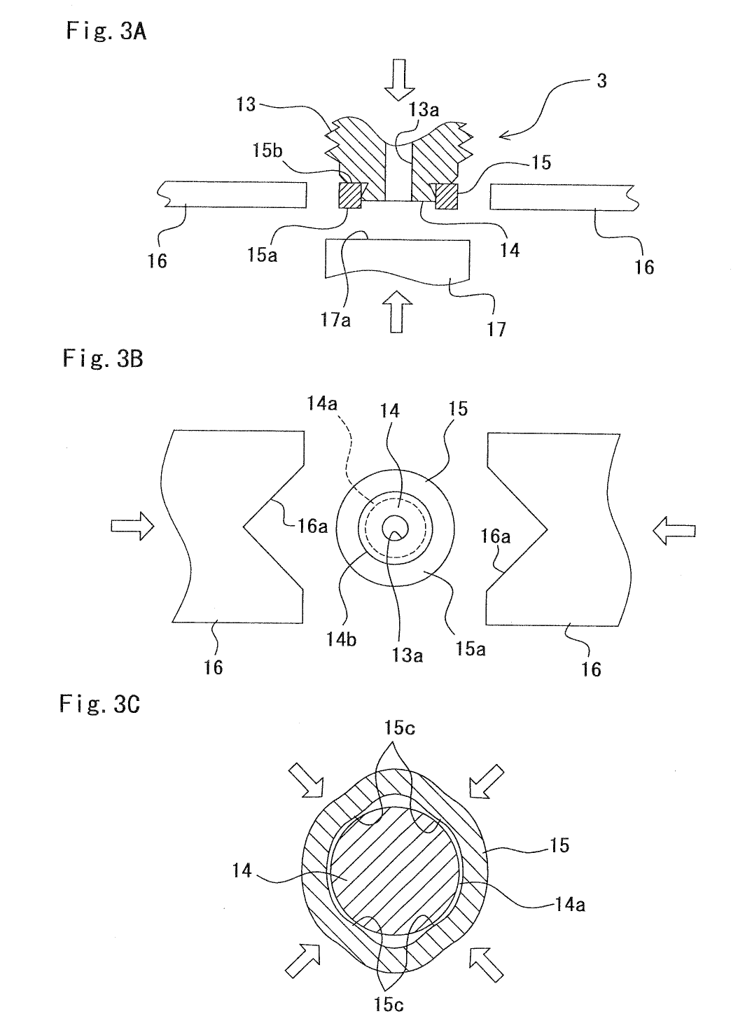

As shown in FIG. 3A, the gasket 15 is formed as a ring having a square or rectangular section cut in a plane including an axis of the gasket, and both end surfaces thereof are formed as flat seal surface 15a and 15b. Furthermore, the gasket 15 has an inner diameter slightly larger than an outer diameter of the gasket holding member 14 so as to be tightly fitted into the gasket holding member 14.

The gasket 15 is formed of a metal material softer than a material forming the fluid introduction sleeve 13 and the gasket holding member 14. For example, when the fluid introduction sleeve 13 and the gasket holding member 14 are formed of stainless steel, the gasket 15 may be formed of iron steal having hardness smaller than that of the stainless steel. The gasket 15 may be formed by a punching-out process, for example.

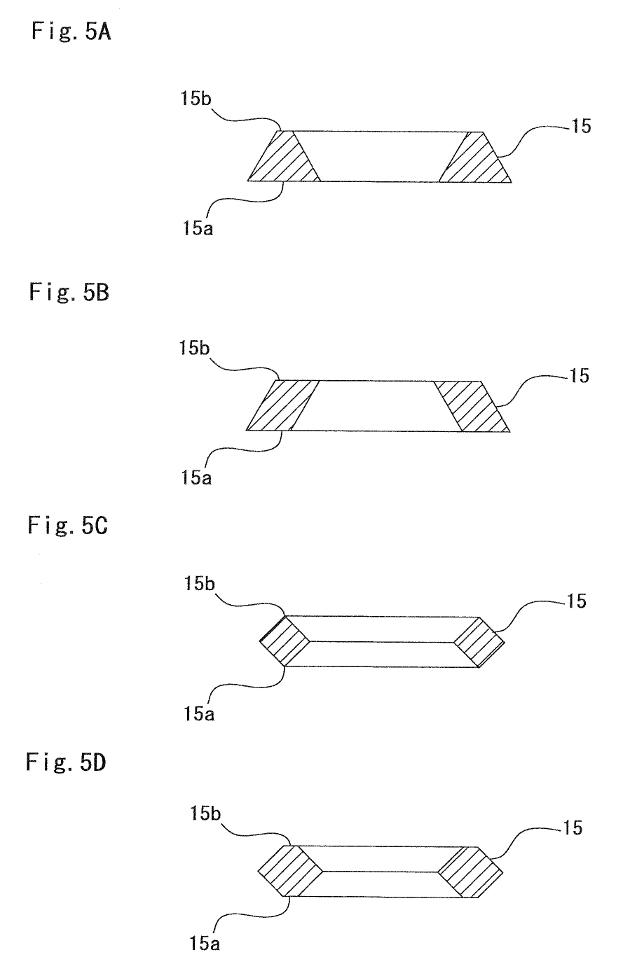

Further, as such gasket 15, there may be employed a gasket having a shape shown in FIG. 3A, a gasket trapezoidal in section as shown in FIG. 5A, a gasket parallelogram in section as shown in FIG. 5B, a gasket having diamond-shaped section as shown in FIG. 5C, or a gasket hexagonal in section as shown in FIG. 5D.

Furthermore, as shown in FIG. 2, the gasket 15 is fixed to the gasket holding member 14 by plastically deforming the gasket 15 in a radially inward direction. That is, the gasket 15 can be surely fixed to the gasket holder 14 by intruding a plastically deformable (or deformed) portion 15c of the inner peripheral portion of the gasket 15 into a groove 14a formed in the outer peripheral surface of the gasket holding member 14 or biting a projection 14b formed to the outer peripheral surface of the gasket holding member 14 into the inner peripheral portion of the gasket. Thus, the gasket 15 can be prevented from coming off from the joint 3 at the time of conveyance of the pressure sensor.

Further, since the gasket 15 can be also prevented from coming off from the joint 3 of the pressure sensor at the mounting process of the pressure sensor, the mounting working can be surely and easily performed, thus being advantageous.

Furthermore, although the gasket 15 is plastically deformed in the radially inward direction, it is not deformed in the axial direction. As a result, the flatness of the seal surfaces 15a and 15b can be maintained. Accordingly, as shown in FIGS. 1 and 2, one of the seal surfaces 15b of the gasket 15 uniformly tightly contacts to the end surface 13c of the fluid introduction sleeve 13, and the other seal surface 15a uniformly tightly contacts a flat seat surface 2a of the set position 2 of the pressure sensor. As a result, the leakage of the fluid such as gas or liquid from the portion between the pressure sensor and the gasket 15 or between the set portion 2 of the pressure sensor and the gasket 15 can be surely prevented.

The mounting of the gasket to the gasket holding member 14 will be performed by a method represented by FIG. 3.

First, with reference to FIG. 3A, the gasket 15 is fitted into the gasket holding member 14 of the joint 3. This fitting working is generally performed after the assembling of the pressure sensor body, but it may be performed at any time during the operation. The gasket 15 is mounted to the gasket holding member 14 so that the seal surface 15a of the gasket IS projects over the front end of the gasket holding member 14.

Next, as shown in FIGS. 3A and 3B, a pair of jigs 16, 16 each having a substantially V-shaped cutout 16a are prepared, and the jigs 16, 16 are then arranged oppositely so as to snap the gasket therebetween from its outer peripheral surface side. It may be desired that the V-shaped cutout 16a has a right angle (90 degrees).

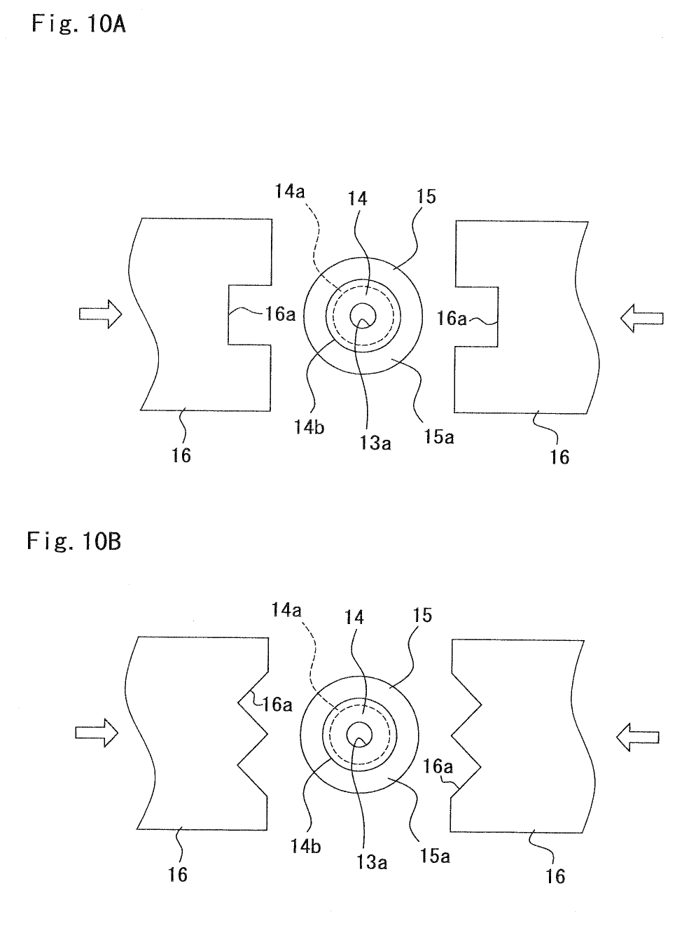

The jig 16 has an abutting edge contacting the gasket 15. although the abutting edge may be formed so as to have a straight shape, in the embodiment, the cutout 16a is formed to the straight edge so as to provide the V-shape. The cutout 16a may be formed so as to provide a recessed channel shape as shown in FIG. 10A, or W-shape or wave-shape as shown in FIG. 10B. By forming such cutouts 16a to the jigs 16, 16, the jigs 16, 16 can contact the outer peripheral surface of the gasket 15 at the plural portions.

In the next step, the gasket 15 is pressed by the paired jigs 16, 16 in the radially inward direction, as shown in FIG. 3C, from four directions to thereby plastically deform the gasket 15. According to this pressing, the plastically deformable portion 15c of the inner peripheral portion of the gasket 15 is intruded into the annular groove 14a of the gasket holding member 14, and as shown in FIG. 2, bring the inner peripheral surface of the gasket into tight contact with the annular projection 14b of the gasket holding member 14. In this operation, four portions of the gasket 15 is liable to be easily deformed, and these four portions are more strongly contacted to the annular projection 14b than the other portions.

As mentioned above, the gasket 15 is plastically deformed, so-called by a calking function, as the plastically deformed portion 15c shown in FIG. 2, and the plastically deformed portion 15c is intruded into the annular groove 14a to thereby fix the gasket 15 to the gasket holding member 14, and hence, the gasket 15 is integrally fixed with the joint 3, thereby preventing the gasket 15 from coming off from the joint 3.

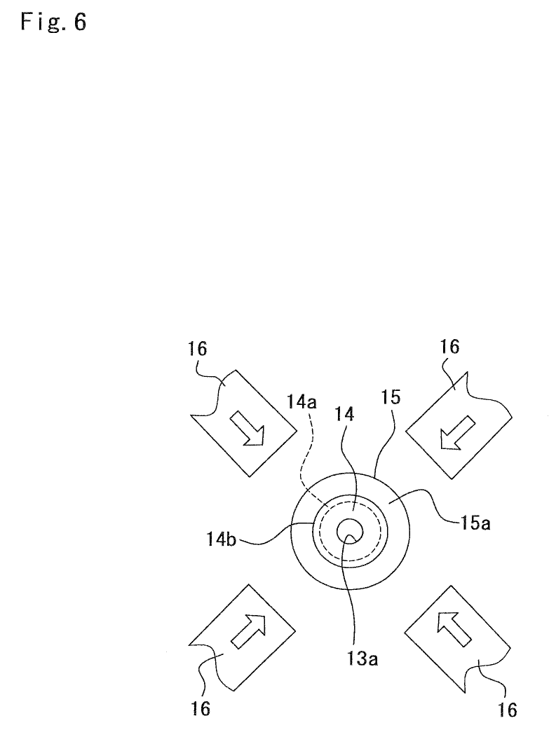

Further, it may be possible, as shown in FIG. 6, to plastically deform the gasket 15 radially inward from the four directions by the paired jigs 16, 16 as like as shown in FIG. 3C.

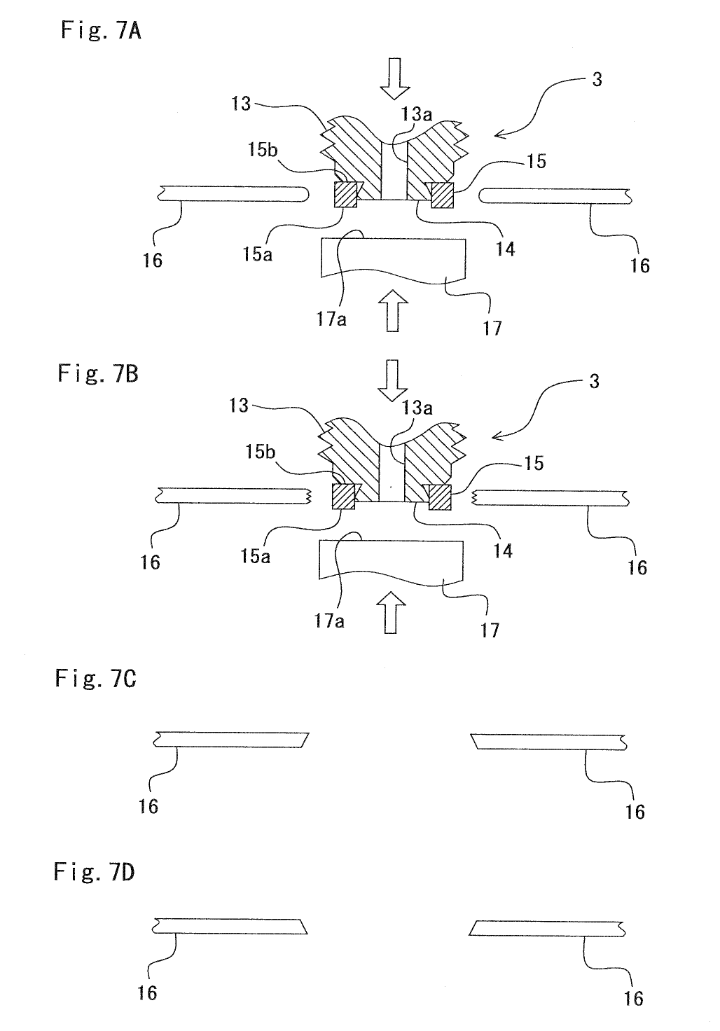

Furthermore, it may be desired for the jig 16 to have a thickness smaller than the thickness of the gasket 15 so as to easily plastically deform the gasket when pressed and so as not to damage the seal surfaces 15a and 15b of the gasket 15. Further, in the illustration of FIG. 3, although the abutting surface of the jig 16 to the gasket 15 is a flat surface, it may be formed as a curved surface as shown in FIG. 7A, or may be formed as an inclined surface as shown in FIG. 7C or 7D. The abutting surface of the jig 16 may be formed as plain smooth surface or irregular surface as shown in FIG. 7B.

In the further step, at an operation of pressing radially inward the gasket by the paired jigs 16, 16, the gasket 15 may be pressed by another jig 17 from the seal surface 15a side to the end surface 13c side of the fluid introduction sleeve 13 as shown in FIG. 3A. The fluid introduction sleeve 13 side may be of course pressed toward the jig 17 side. The jig 17 has a flat surface area 17a larger than that of the gasket 15.

Accordingly, even if the inner peripheral surface of the gasket 15 is plastically deformed, the seal surfaces 15a and 15b are prevented from being deformed toward the axial direction of the gasket 15 to thereby maintain the flatness of the seal surfaces 15a and 15b. Thus, the improved sealing performance between the seal surfaces 15b, 15a and the end surface 13c of the fluid introduction sleeve 13 and the seat surface 2a of the set position 2 of the pressure sensor can be preferably maintained without lowering, thus preventing the fluid from leaking.

In a case when the joint 3 is coupled to the flanged member 12 after the fitting of the gasket to the gasket holding member 14 of the joint 3, the joint 3 holding the gasket 15 is coupled to the pressure sensor.

According to the steps and operations mentioned above, the pressure sensor body 1 is integrally jointed with the joint 3 and the gasket 15, and the integrated entire structure is conveyed as a pressure sensor, or is mounted to the predetermined set position 2 as shown in FIG. 1.

### Second Embodiment

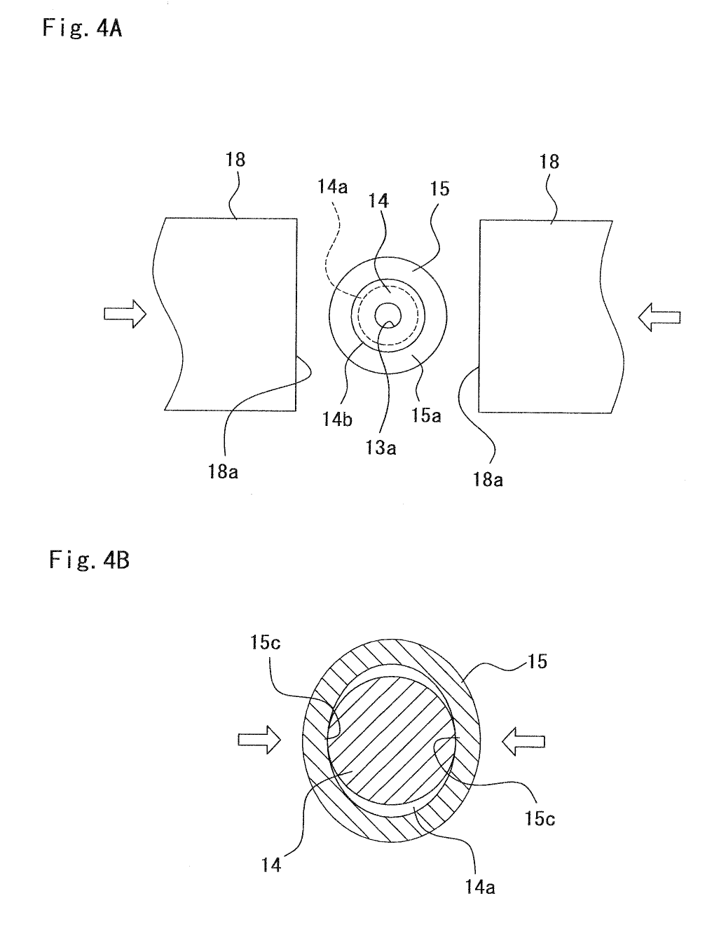

FIG. 4 represents the second embodiment of the present invention, and as shown in FIG. 4A, the gasket 15 is pressed radially inward by a pair of jigs 18, 18 having front edges formed as flat surfaces 18a, 18a.

When the gasket 15 is pressed by the jigs 18, 18, as shown in FIG. 4B, the gasket 15 is deformed elliptically as a whole, and the plastically deformable portion 15c formed to the inner peripheral portion of the gasket 15 is intruded into the annular groove 14a of the gasket holding member 14, thereby integrally fixing the gasket 15 to the joint 3.

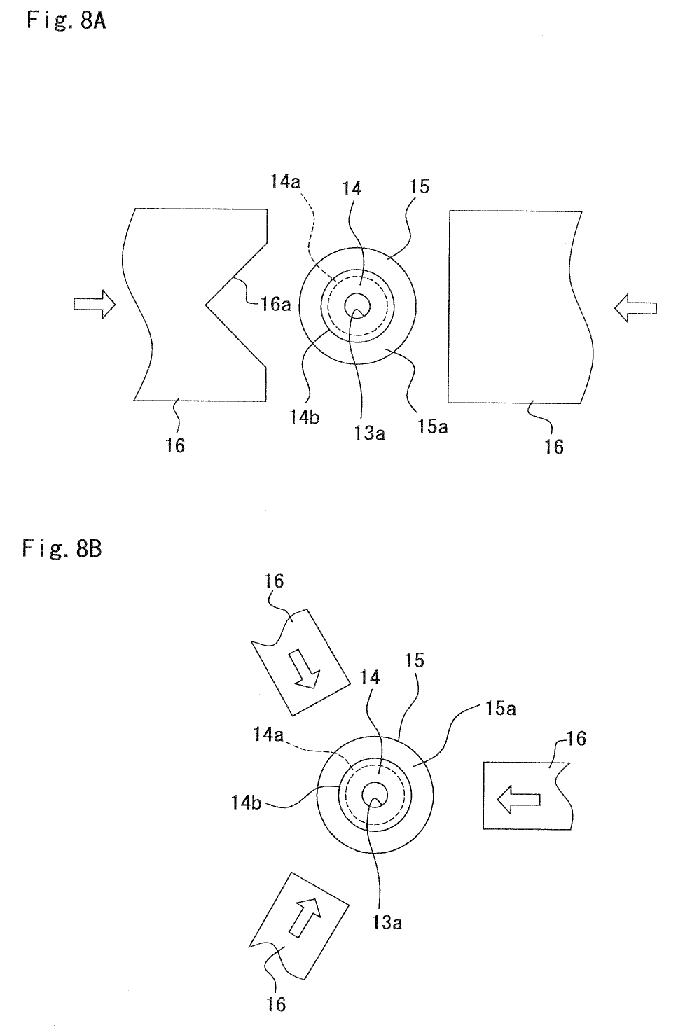

In this second embodiment, as shown in FIG. 8A, a cutout 16a may be formed to an abutting edge portion of one of the jigs 16 as in the first embodiment. According to this structure, the gasket 15 is pressed from three directions radially inward, and thus, the gasket 15 is plastically deformed at three portions. In this case, as shown in FIG. 8B, three jigs 16 may be utilized so as to press the gasket 15 from three directions radially inward.

The structures other than those mentioned above are substantially the same as those of the first embodiment, and the duplicated description is hence omitted herein by adding the same reference numerals in the first embodiment.

### Third Embodiment

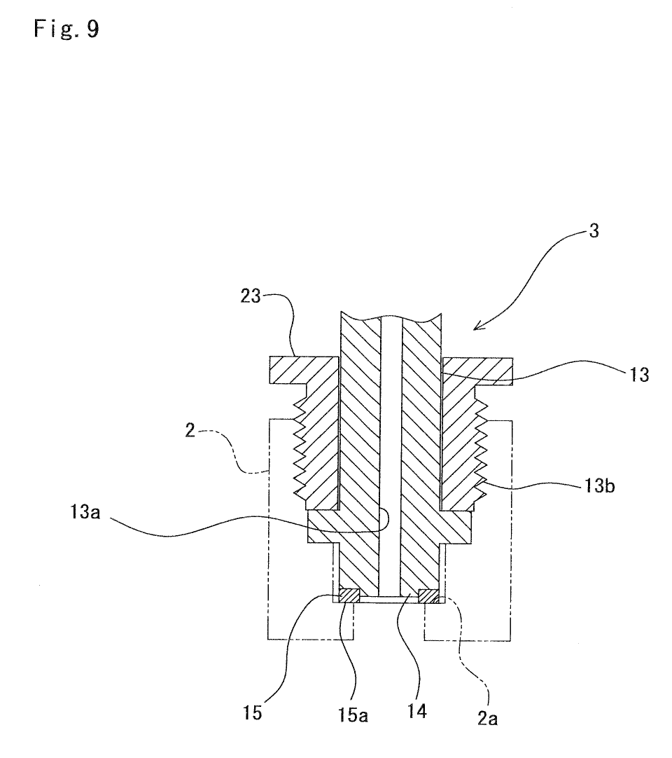

FIG. 9 represents the third embodiment of the present invention. As shown in FIG. 9, the male screw portion 13b shown in FIG. 1 is eliminated from the fluid introduction sleeve 13. Thus, the pressure sensor body 1 is fixed to the set position 2 by another member such as union screw 23 or like.

The structures other than those mentioned above are substantially the same as those of the first embodiment, and the duplicated description is hence omitted herein by adding the same reference numerals in the first embodiment.

It is to be further noted that the present invention is not limited to the described embodiments and many other changes and modifications may be made without departing from the scopes of the appended claims.

For example, in the described embodiment, although the measuring device is defined as pressure sensor, the present invention is not limited thereto and applicable to a temperature meter, or other sensors such as fluid flow meter for measuring physical quantity of fluid, machinery, and the like. Furthermore, the gasket may be plastically deformed by using a plurality of paired jigs.

What is claimed is:

1. A joint for a measuring device, comprising:
a fluid introduction sleeve to which a body of a measuring device is mounted;
a gasket holding member mounted to the fluid introduction sleeve so as to project over a front end of the fluid introduction sleeve; and
a gasket having a ring-shape and held by the gasket holding member,
wherein the gasket is held to the gasket holding member by plastically deforming the gasket in a radially inward direction thereof.

2. The joint for a measuring device according to claim 1, wherein the gasket is held by the gasket holding member such that a seal surface of the gasket projects over a front end of the gasket holding member.

3. The joint for a measuring device according to claim 1, wherein the gasket is formed, in an inner peripheral surface thereof, with a plastically deformable portion, and the gasket holding member is formed, in an outer peripheral surface thereof, with a groove into which the plastically deformable portion is intruded.

4. The joint for a measuring device according to claim 3, wherein the groove has a tapered wall widening toward the front end of the gasket holding member.

5. The joint for a measuring device according to claim 1, wherein the gasket holding member is formed, in an outer peripheral surface thereof, with a projection, which contacts an inner peripheral surface of the gasket.

6. The joint for a measuring device according to claim 5, wherein the projection has a tapered wall widening toward the front end of the gasket holding member.

7. The joint for a measuring device according to claim 1, wherein the measuring device is a pressure sensor.

8. The joint for a measuring device according to claim 1, wherein the gasket is formed of a material softer than that of the gasket holding member.

9. The joint for a measuring device according to claim 1, wherein the fluid introduction sleeve is a screw cylinder screwed with a predetermined set position formed to the measuring device.

10. A method of manufacturing a joint for a measuring device comprising the steps of:
preparing a fluid introduction sleeve to be connected to a measuring device and a gasket holding member mounted to the fluid introduction sleeve so as to project over a front end surface of the fluid introduction sleeve;
applying a gasket to the gasket holding member; and
pressing the gasket in a radially inward direction against an outer peripheral surface of the gasket holding member to thereby form a plastically deformable portion to an inner peripheral surface of the gasket to thereby mount the gasket to the gasket holding member.

11. The method of manufacturing a joint for a measuring device according to claim 10, wherein the gasket is pressed in the radially inward direction, and simultaneously, the gasket is pressed in an axial direction.

12. The method of manufacturing a joint for a measuring device according to claim 10, at least a pair of jigs are prepared and the gasket is sandwiched by the jigs from the outer peripheral side thereof to thereby plastically deform the gasket.

13. The method of manufacturing a joint for a measuring device according to claim 12, wherein the gasket is pressed radially inward by the at least a pair of jigs, and simultaneously, the gasket is pressed in the axial direction thereby by sandwiching the gasket between the fluid introduction sleeve and another jig.
